(19) United States
(12) Patent Application Publication
(10) Pub. No.: US 2010/0162314 A1
(43) Pub. Date: Jun. 24, 2010

(54) ENHANCED ELECTRONIC PROGRAM GUIDES, SYSTEMS AND METHODS

(76) Inventor: David P. Meare, Oldham (GB)

Correspondence Address: DORSEY & WHITNEY LLP;on behalf of EchoStar Technologies, L.L.C., 370 Seventeenth St., Suite 4700, Denver, CO, 80202-5647, US

(21) Appl. No.: 12/342,807

(22) Filed: Dec. 23, 2008

(51) Int. Cl. H04N 5/445

(52) U.S. Cl. 725/44

(57) ABSTRACT

An enhanced electronic program guide for television programming may be provided by including at least one displayable indicator that is associated with at least one of the programs in the electronic program guide and indicative of the genre of the at least one of the programs. The displayable indicator may be displayed with the program in the electronic program guide, and thus may be more informative to a user, particularly for programs for which the electronic program guide provides a truncated title or name as displayed. In embodiments, the displayable indicator may be a color, a symbol, an icon or the like. Additionally, embodiments may include a displayable indicator, such as an icon, for programs of a particular program series. Such an icon may be displayed with programs of the series in the electronic program guide, and thus may facilitate identification of programs of interest to a user.

### TECHNICAL FIELD

The inventive field relates generally to electronic program guides (EPGS) used by a client device, such as a set top box (STB), digital video recorder (DVR) or similar device. The inventive field also relates to providing an enhanced electronic program guide for such devices.

### BACKGROUND DISCUSSION

The proliferation of subscription television programming, the increasing number of available channels, and the corresponding increase in television programming have led to continued development of onscreen program directories and guides. Such onscreen programming solutions, collectively referred to herein as electronic program guides, have ranged from program information for each channel scrolling vertically across the screen to user controllable interfaces that allow users to examine scheduling information describing television programs currently on-air and to be broadcast in the future.

In direct broadcast satellite (DBS) systems, EPG information is periodically downloaded and updated, usually at regular intervals. Prior art approaches have allowed users to examine scheduling information that has been downloaded to the client device, either by scrolling sequentially through listings corresponding to one-half hour or hour increments or by directly accessing individual timeslots. Further, some EPGs may allow a user to directly access desired programs or even set programs to be recorded automatically.

Known EPGs provide access to program information in various ways. EPGs generally provide only program information, such as the channel, the time slot and duration, and the title of the program. Other information about the program, such as a brief description of the content and/or the names of the actors, may also be presented. Known EPGs also provide limited user interactivity, such as moving between time slots to view program information and setting current or future programs for recording.

### SUMMARY

Conventional EPGs may not provide sufficient information regarding a particular program for the user to determine whether that program may be of interest to the user. This is particularly true for an “at-a-glance” view of multiple programs displayed in an EPG. For example, an EPG may be displayed with titles of particular programs that are truncated to such a degree that the user is unable or finds it difficult to determine whether the particular programs may be of interest. Thus, there is a need to provide additional information regarding programs via an EPG in such a manner that facilitates a user determining whether a particular program may be of interest, particularly when the title of the program is truncated.

Various embodiments relate to systems and processes for enhancing an EPG. Enhancements may relate to providing a user with information associated with or related to a particular program that is displayed in the EPG. In particular, enhancements may relate to providing such additional information as part or all of the information displayed in the EPG for the particular program.

Some embodiments may comprise a process of providing an enhanced EPG for display on a viewing screen. The process may include: providing an electronic program guide, the electronic program guide divided into at least a two-dimensional grid of timeslots containing program information corresponding to programs scheduled to be broadcast during respective ones of the timeslots; and transmitting the electronic program guide and at least one displayable indicator from a television service provider to a client device, the at least one displayable indicator associated with at least one of the programs, indicating a genre of the at least one of the programs and configured to be displayed with the at least one of the programs in the timeslots of the electronic program guide.

In some embodiments, the process may include determining the genre of the at least one of the programs, and associating the at least one displayable indicator with at least one of the programs based on the determined genre.

In some embodiments, the at least one displayable indicator is non-textual. In some embodiments, the at least one displayable indicator comprises a color. In some embodiments, the at least one displayable indicator comprises an icon.

In some embodiments, the at least one displayable indicator is configured to be displayed in the electronic program guide as a leftmost portion of the program information in the timeslot(s) of the at least one of the programs. In some embodiments, the at least one displayable indicator is configured to be displayed in the electronic program guide as a portion of the program information preceding a name of the at least one of the programs in the timeslot(s) of the at least one of the programs.

Other embodiments may also comprise a process of providing an enhanced EPG for display on a viewing screen. The process may include: receiving an electronic program guide from a television service provider, the electronic program guide divided into timeslots containing program information corresponding to programs scheduled to be broadcast during respective ones of the timeslots; associating at least one displayable indicator with at least one of the programs based on a genre of the at least one of the programs; outputting the electronic program guide in an at least two-dimensional grid of the timeslots; and outputting the associated at least one displayable indicator for display in the timeslot(s) of the grid of the at least one of the programs in the electronic program guide.

In some embodiments, the process may include: determining the genre of the at least one of the programs; and associating the at least one displayable indicator with at least one of the programs based on the determined genre.

In some embodiments, associating the at least one displayable indicator with the at least one of the programs based on the genre of the at least one of the programs comprises determining that a name of the at least one of the programs to be displayed will be truncated as displayed in the electronic program guide.

Some embodiments may provide an enhanced electronic program guide system in the form of a computer-readable storage medium. The medium may include instructions stored thereon that, when executed by a processor, cause the processor to provide an electronic program guide for display on a viewing screen by performing any of the foregoing methods.

Some embodiments may provide an enhanced EPG in the form of a system or device for providing an electronic program guide for display on a viewing screen. Embodiments of systems may be implemented at a television service provider and/or may include a transmission system for transmission of the enhanced electronic program guide and/or components thereof to a client device. Embodiments of devices may be implemented at a client device configured to receive television programming and programming information from a television service provider. Embodiments of systems and devices may also be implemented as various components of a television distribution system, including but not limited to a television service provider and/or a client device.

By using various embodiments, an enhanced EPG may be more informative and/or more useful to a user and may also provide additional functionality and/or user interactivity, as compared to known EPGs.

### BRIEF DESCRIPTION OF THE DRAWINGS

Various details of the present invention may be better understood on reading the following detailed description of non-limiting embodiments, and on examining the accompanying drawings, in which:

FIG. 1 is a block diagram illustrating major components of an example of a direct broadcast satellite television system.

FIG. 2 is a display illustrating an example of a display of an EPG.

FIG. 3 is a display illustrating an example of a display of an enhanced EPG.

FIG. 4 is a display illustrating an example of a table of icons that may be employed with the enhanced EPG of FIG. 3.

FIG. 5 is a display illustrating another example of a display of an enhanced EPG.

FIG. 6 is a display illustrating another example of a display of an enhanced EPG.

FIG. 7 is a display illustrating another example of a display of an enhanced EPG.

FIG. 8 is a display illustrating an example of a table of icons that may be employed with the enhanced EPG of FIG. 7.

FIG. 9 is a flowchart illustrating a process of providing an enhanced EPG.

### DETAILED DESCRIPTION OF EMBODIMENTS

As used herein, the terms “electronic programming guide” or “EPG” are intended to encompass an interface provided to a user and an underlying television broadcast system or component that supports functionality with the programming content. The enhanced EPG described herein may be considered to be embodied in the interface, a display, such as a televisions or monitor, software and/or hardware, either alone or in combination. As such, the term EPG is used in a broad sense for the sake of clarity in the description, without being limiting.

The embodiments shown in the Figures illustrate processes and systems that may provide an enhanced EPG. Enhancements may relate to providing an EPG that provides additional information regarding programs, such as information that identifies the genre or theme of programs and/or particular programs. In particular, enhancements may relate to providing an EPG with a displayable indicator associated with a program that provides information regarding the associated program. For example, the displayable indicator may indicate a genre or theme of the associated program. Alternatively or additionally, the displayable indicator may indicate a particular program series of the associated program. As described herein, associating a displayable indicator with a program should be understood to encompass associating the displayable indicator with other information regarding the program and/or with a corresponding time slot in an EPG for the program.

Embodiments of the processes and systems that may provide an enhanced EPG as described herein may facilitate a user's determination regarding the content and/or the user's interest in the associated program. As discussed above, in cases where the name of a program is truncated as displayed in the EPG, the displayable indicator may be displayed to provide more information to the user. In some embodiments, the displayable indicator may be in addition to the name or title of the program. Alternatively, the displayable indicator may be in place of the name of the program. In some embodiments, the displayable indicator may be non-textual.

The displayable indicator may be displayed in the EPG upon receiving a request of a user for the indicator, for example, at a client device, such as from a remote control device. Alternatively, the displayable indicator may automatically be displayed in the EPG, for example, when such a feature is enabled at the client device. In some embodiments, displayable indicators may automatically be displayed in the EPG only for associated programs that have truncated names displayed in the EPG. Alternatively, displayable indicators may automatically be displayed in the EPG for all programs displayed in the EPG.

In some embodiments, the displayable indicator may comprise a color, a shading, a highlighting, or the like. In such embodiments, different colors and/or shading may be employed to indicate different genres or themes. For example, names of programs of a same genre displayed in the EPG may be displayed in a same particular color. Alternatively or additionally, when programs are displayed in a grid-type EPG, the time slots for programs of the same genre displayed in the EPG may be highlighted, colored and/or shaded in a same manner. Thus, embodiments described herein may provide an enhanced EPG that is more informative to a user by providing identification of and/or differentiation between programs of particular genres.

In some embodiments, the displayable indicator may comprise a symbol or an icon. In such embodiments, different symbols or icons may be employed to indicate different genres or themes. Additionally or alternatively, different symbols or icons may be employed to indicate programs of different program series. In some embodiments, symbols and icons may be employed in combination with colors, shading and/or highlighting. For example, a color of a time slot of a program may indicate the genre of the program, while the icon may indicate the program series of the program.

In some embodiments, the displayable indicator(s) may be associated with the program(s) before being transmitted to a client device. For example, the displayable indicator(s) may be associated with the program(s) by a television service provider and then transmitted with the EPG information. After being received by the client device, the displayable indicator(s) may be displayed in the EPG based on operation of the client device and/or the EPG as described herein.

It should be understood that a television service provider may receive channels and program information from another source, such as a television network. In such case, the program information for such channels may include one or more displayable indicators associated with the programs of the channels. Accordingly, the displayable indicator(s) may be associated with the program(s) by an entity other than the television service provider as well.

In general, embodiments described herein may provide an enhanced EPG that is more informative to a user. In particular, embodiments described herein may allow an EPG to display a larger amount of programming time, and thus generally a greater number of time slots per channel, at a given time while providing an EPG that is relatively informative and/or useful to a user. By employing displayable indicators, embodiments described herein may provide an enhanced EPG that provide information to the user regarding programs that is not entirely, or at all, dependent on the names of the programs. As such, embodiments described herein may address problems encountered with uninformative, truncated titles of programs displayed in an EPG.

Various implementations are possible. For example, satellite, cable, analog or digital terrestrial, internet or other broadcasting technologies may be suitable. Thus, while the following description provides an example in the context of a television service provider employing a satellite broadcast system, it should be understood that such description is not limiting.

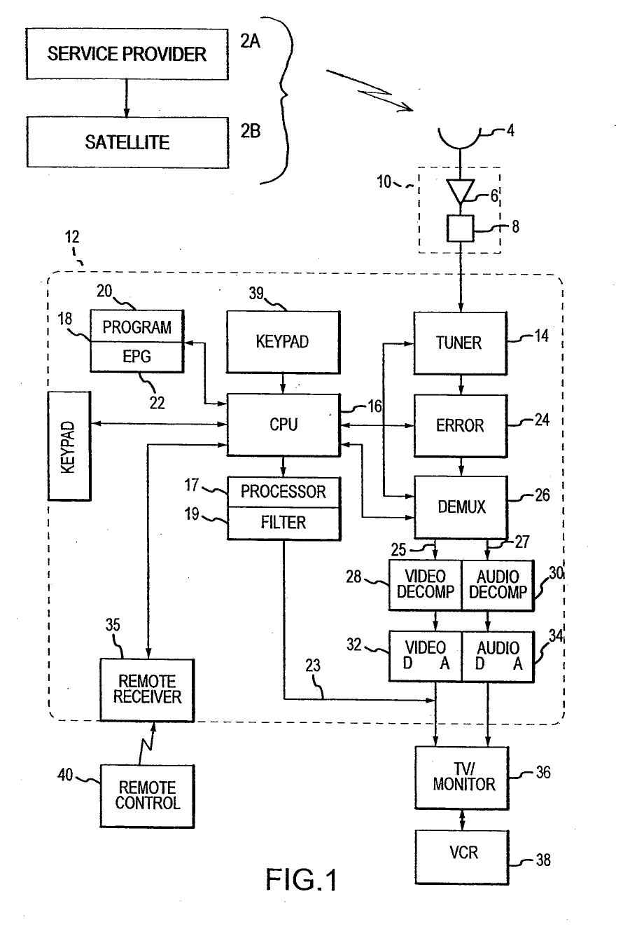

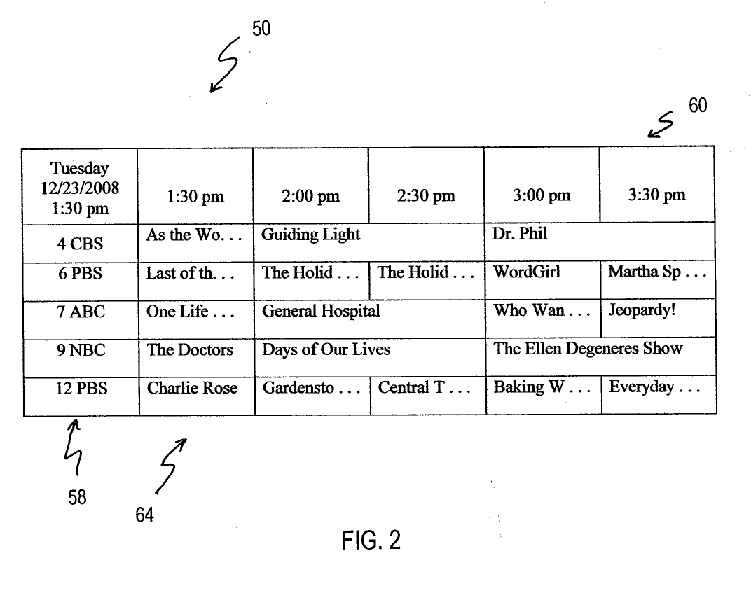

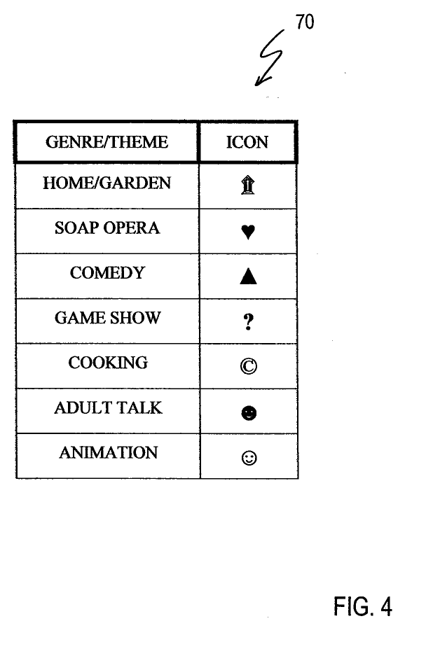

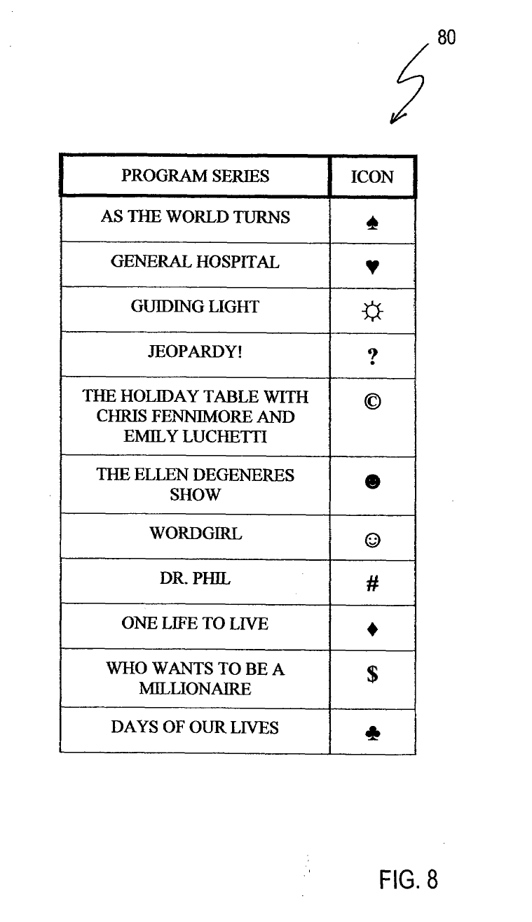

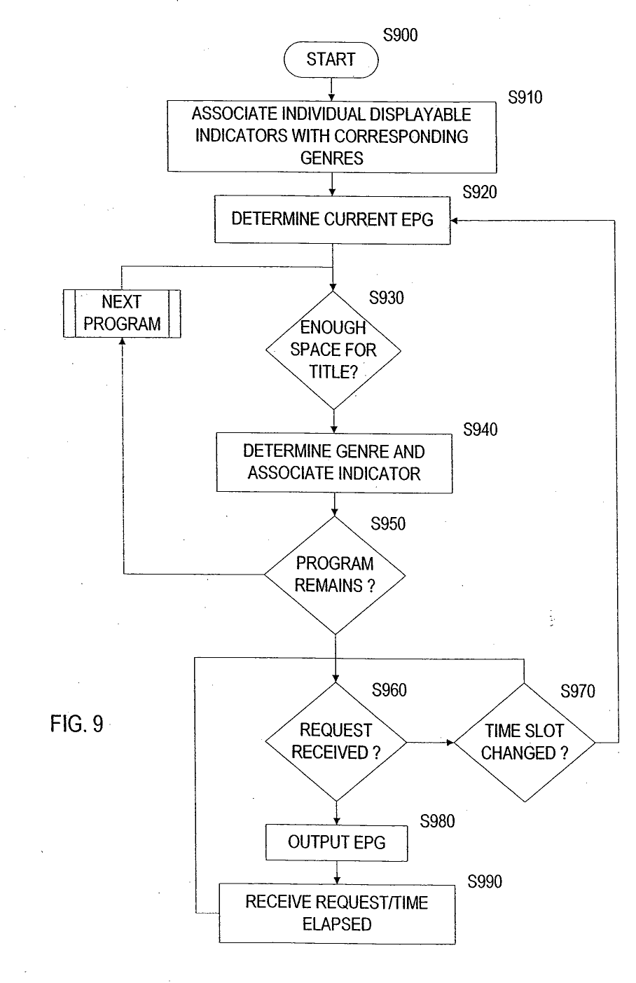

The block diagram shown in FIG. 1, the displays shown in FIGS. 2, 3 and 5-7, the tables shown in FIGS. 4 and 8 and the flowchart shown in FIG. 9 are for illustration only and are not intended to represent the only possible displays, process flows and system configurations. In particular, it should be understood that process steps may be added, omitted and reordered as may be suitable to a particular application. Also, individual components may be added, omitted, replaced and interrelated as may be suitable to a particular application. All details appurtenant to implementing the exemplary processes and systems that are well understood in the art are omitted for simplicity and clarity.

FIG. 1 is a block diagram that shows various components that may be used to implement various features of the present invention. For example, a direct broadcast satellite system incorporating packetized transmission according to the MPEG-2 standard may be used, although any programming source that includes an EPG, or transmits data to be incorporated into an EPG, is contemplated. Encrypted direct broadcast satellite (DBS) signals may be transmitted from a source 2, such as a television service provider 2A via a satellite 2B. Such signals may be received as downlinked signals by a satellite antenna 4, such as a parabolic dish of approximately eighteen to thirty-six inches in diameter in one embodiment. Front end processing of the satellite signals may be accomplished by a low noise block converter feed (LNBF) provided in the antenna focal point. This may include a converter module 10 with a low noise amplifier 6, which receives the signals from the feed, and by a down converter 8, which converts the entire frequency band of the satellite signals to a lower frequency range that may be efficiently transmitted, for example, via coaxial cable to a client device, such as a satellite receiver 12. A tuner 14 may select a specific channel from the downlinked signal 2 and feed the selected channel to an error correction and packet synchronization module 24. The error correction and packet synchronization module 24 may output a fully compliant transport stream, which may be directed to a packet demultiplexer 26. Various encoding or formats may be used.

The packet demultiplexer 26 may be an integrated circuit that accepts the packetized, time domain multiplexed data stream of the transport stream and routes the packets to various areas within the satellite receiver 12. Audio may be output as an audio stream 27, which may be accepted by an audio decompresser 30. Video may be output as a video stream 25, which may be accepted by a video decompresser 28. The audio stream 25 and the video stream 27 may be fully compliant audio and video program elementary streams, respectively. In addition to routing packets of data, the packet demultiplexer 26 may also descramble encrypted data, provide various buffering of the formatted data, and handle a program clock reference to keep a local clock synchronized with the clock at the uplink center (e.g., service provider 2A). Data 29 may be output from the demultiplexer 26 and routed to a central processing unit (CPU) 16, which may assemble the data 29 into an EPG 22 stored in a memory or other storage medium 18.

The video decompresser 28 and the audio decompresser 30 may accept one or more video stream 25 and/or audio stream 27, respectively, and decompress them into baseband digital signals. The video stream 25 may then fed to a video digital to analog converter 32 and the audio stream 27 may be fed to a video digital to analog converter 34. The converters 32 and 34 may decode the digital signals and output resulting analog baseband signals to a TV/monitor 36 and/or a VCR device 38.

The EPG 22 may comprise a database or otherwise access a database containing information including, for example, names or titles of viewing events (programs), corresponding channel numbers and names, brief descriptions of the programs, start and finish times, and rating and content information related to the events. The central processing unit 16 may execute an EPG program 20, which may take the information stored in the EPG 22 and output a graphic file to a processor 17. The processor 17 may process the graphic file and output a signal, which, after being filtered by a filter 19, may become a video baseband signal 23 that may be combined with the video baseband signal 25 to be displayed on the television/monitor 36.

A user may manipulate the satellite receiver 12 via a keypad 39 or a remote control device 40. The remote control device 40 may communicate with the CPU 16 by sending an infrared, radio frequency, or other wired or wireless signal to a remote receiver 35, which may transfer commands to the CPU 16.

The EPG program 20 may comprise an instruction set that creates the EPG 22 and allows a user to manipulate the EPG 22, as discussed further below. While the EPG program 20 may be implemented as hardware, the EPG program 20 may alternatively or additionally comprise a software program stored in the memory 18. Memory 18 may be random access memory (RAM), but also may be flash, ferroelectric, or other nonvolatile memory, or conventional RAM with a battery backup. An LSI 64002 microprocessor may be used for the central processing unit 16. Also, the processor 17 may be an NTSC processor, such as the Sony CXD 1910, or anything else suitable.

As illustrated in FIG. 2, programming information contained in the EPG 22 may be displayed on the TV/monitor 36 in the form of a screen 50. As an example, the screen 50 may allow the user to examine programming information contained in the EPG 22 for programs scheduled for up to at least two days into the future. The user may summon the screen 50, for example, by pressing the GUIDE key on the remote control device 40 or the keypad 39.

Current date, day of the week, and time may be displayed in the upper left corner of the screen 50. The screen 50 may list channels 58 in a column at the left edge of the screen, and timeslots 60 in a row across the top of the screen. For example, timeslots 60 may be divided into 30 minute intervals, but other intervals may be used. Titles or descriptions corresponding to individual programs may be displayed in the center of the screen 50, in a grid 64 defined by the channels 58 and the timeslots 60. Upon summoning of the screen 50, a cursor (not shown) may be placed upon the program corresponding to the programming selection currently being viewed. The cursor may be implemented in any desired manner, for example, by drawing a box around the program, highlighting the program, or the like. Any of the programs may be selected for viewing by moving the cursor to the desired program via arrow keys located on the remote control device 40 or the keypad 39 and pressing the SELECT key, for example. If the selected event is to be shown in the future, the user may set up an event timer.

The user may traverse the channels 58 by scrolling via the vertical arrow keys on the remote control device 40 or the keypad 39. The timeslots 60 may be traversed either by scrolling via the left and right arrow keys, or by specifying a number of hours, forward and/or reverse as available. The number of hours available to the user may be dependent on the total amount of information contained in the downlink datastream.

For example, the user may traverse the timeslots 60 by entering the number of hours and then pressing one of the horizontal arrow keys. If the right arrow key is pressed after entering a number “24,” the screen 50 may display the timeslot located (in this example) 24 hours later than the timeslot indicated by the cursor, and the cursor may be moved to the program corresponding to the new timeslot and currently selected channel. If the left arrow key is pressed after entering the number “24,” the screen 50 may display the timeslot located (in this example) 24 hours earlier than the timeslot indicated by the cursor, and the cursor may be moved to the program corresponding to the new timeslot and currently selected channel.

If the desired program information is not currently in memory, the system may access the information from the downlink datastream. A message may appear on the TV/monitor 36 informing the user that the system is retrieving EPG information from the satellite. This may allow the user to either wait for the update or cancel the operation. If the desired information is not contained within the data stream 2, the user may be informed; otherwise, the desired information may be displayed on the TV/monitor 36 once retrieved.

In addition to such use control of displayed programming information, the EPG 22 may be linked to additional information. For example, while a particular program is outlined or highlighted, the user may press an INFO key. In response, the CPU 16 may retrieve additional information from the EPG 22 associated with the program. Such information may include the name or title of the program, the genre of the program, a synopsis of the content of the program, the main actors of the program, and the like. Once retrieved, the processor 17 may cause the additional information to be displayed on the TV/monitor 36. The additional information may be displayed in addition to the program information, or may replace or overlay the program information in the display screen.

Thus far, one example for implementing an EPG has been described. It should be understood, however, that any known systems and methods for implementing an EPG as known in the art may be employed to achieve the basic operations of an EPG as described above, or other operations of an EPG as may be appropriate or desired for a given application. In other words, although embodiments are described herein with respect to the implementation of an EPG in the form of a grid as described above, it should be understood that other implementations are possible and not excluded.

Referring again to FIG. 2, it can be seen that the space available for information regarding programs may be limited by the layout of the screen 50 displaying the EPG. In the example shown, each program is allotted space according to the time slot or slots during which the program is scheduled to air. For example, referring to the programs of channel 4 CBS, the program “As the World Turns” is scheduled to run for one hour, from 1:00 pm to 2:00 pm, the program “Guiding Light” is scheduled to run for one hour, from 2:00 pm to 3:00 pm, and the program “Dr. Phil” is scheduled to run for one hour, from 3:00 pm to 4:00 pm. In FIG. 2, as the current time is 1:30 pm, only one half-hour time slot is displayed with information for the program “As the World Turns,” while two half-hour time slots are displayed with information for each of the programs “Guiding Light” and “Dr. Phil.” Because the one half-hour time slot available for information regarding the program “As the World Turns” provides insufficient space, the title or name is truncated. In comparison, the two half-hour time slots displayed for the other two programs for that channel provide sufficient space for the entire name.

Referring to the programs of channel 6 PBS, the programs “Last of the Summer Wine,” “The Holiday Table With Chris Fennimore and Emily Luchetti” (two episodes), “WordGirl” and “Martha Speaks” are each scheduled to run for a half hour, respectively. The one half-hour time slots displayed with information for each of these programs provides insufficient space for the full titles, other than the program “WordGirl.”

It should be understood that the number of time slots displayed, the size of the time slots and the amount of program information that will fit within the time slot(s) for each program will vary as a matter of design choice. However, it should be understood from FIG. 2, that limits on screen size, font size for text, a desire to provide information for more time slots in a single screen, and other practical considerations will limit the amount of information regarding individual programs that may be displayed at a given time. In the example of FIG. 2, the truncated names of programs may or may not be sufficient for a user, depending on the user's familiarity with available programming.

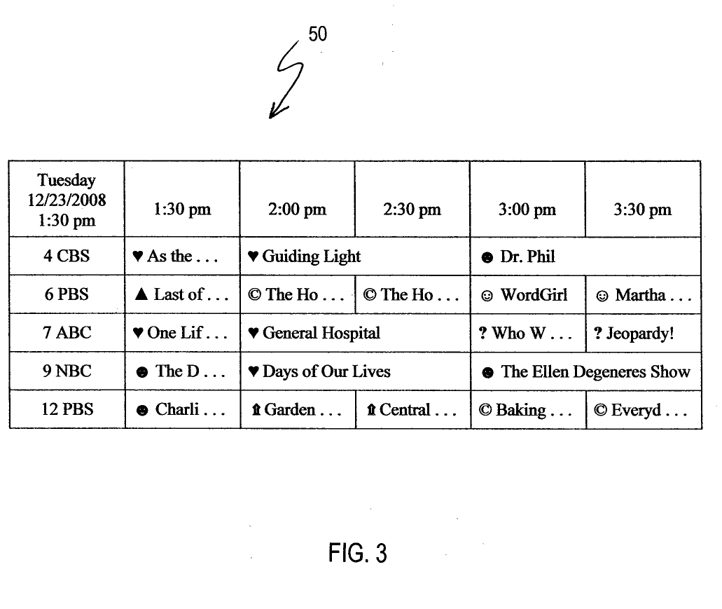

One example of an approach that provides an enhanced EPG is illustrated in FIG. 3. In this example of an enhanced EPG displayed on the screen 50, a displayable indicator may be associated with each program of a particular genre. For example, a displayable indicator in the form of a symbol or icon, such as a “♡”, may be associated with programs of a “soap opera” genre. Thus, the “♡” may be associated with and displayed with the titles of the programs “As the World Turns,” “Guiding Light,” “One Life to Live,” “General Hospital” and “Days of Our Lives.” Different displayable indicators in the form of different symbols of icons may be associated with and displayed with the titles of corresponding programs as well.

As also illustrated in FIG. 3, a [symbol] may be associated with programs of a “adult talk” genre. Thus, the [symbol] may be associated with and displayed with the titles of the programs “Dr. Phil,” “The Doctors,” “The Ellen Degeneres Show” and “Charlie Rose.” Also, a “▴” may be associated with programs of a “comedy” genre. Thus, the “▴” may be associated with and displayed with the title of the program “The Last of the Summer Wine.” Further, a “©” may be associated with programs of a “cooking” genre. Thus, the “©” may be associated with and displayed with the titles of the programs “The Holiday Table With Chris Fennimore and Emily Luchetti,” “Baking With Julia” and “Everyday Food.” Similarly, a [symbol] may be associated with programs of a “children's show,” “cartoon” or “animation” genre. Thus, the [symbol] may be associated with and displayed with the titles of the programs “WordGirl” and “Martha Speaks.” Similarly, a “?” may be associated with programs of a “game show” genre. Thus, the “?” may be associated with and displayed with the titles of the programs “Who Wants To Be A Millionaire” and “Jeopardy!” Also, a “ [symbol] ” may be associated with programs of a “home/garden” genre. Thus, the “ [symbol] ” may be associated with and displayed with the titles of the programs “Gardenstory: Inspiring Spaces, Healing Places” and “Central Texas Gardener.”

It should be understood that the genres and the icons depicted in FIG. 3 are only illustrative, and that any suitable genres or themes may be defined for programs, and any suitable symbols or icons may be used. For example, rather than a stylistic letter “C” for a “cooking” genre, an icon depicting a frying pan, a plate and eating utensils, or the like may be more suggestive of the genre. However, it should be understood that the displayable indicators should provide information to a user regarding the program content, such as theme or genre, so as to improve the informativeness of the EPG, particularly for truncated titles.

As such, a user may be provided with, as part of the EPG screen, as a separate screen, or as a hard copy (e.g., user manual, quick reference guide, or the like), a legend of some kind that delineates the genres associated with the displayable indicators. For example, in the case of the displayable indicators in the form of icons shown in FIG. 3, a table 70 as illustrated in FIG. 4 may list each of the genres and the icons associated therewith. The table 70 may enable a user who is unfamiliar with the icons to identify an icon associated with a genre of interest, for example.

It should also be understood that the genres and the icons depicted in FIG. 3 may be predetermined and transmitted to the client device for display. Alternatively, the genres may be predetermined and the particular icons to be associated with the respective genres may be selected by a user. For example, a default set of icons may be associated with respective defined genres, and a user may be permitted to select from various icons stored at the client device to replace ones of the default icons as desired, such as to associate icons that are more suggestive of the particular genres to the specific user.

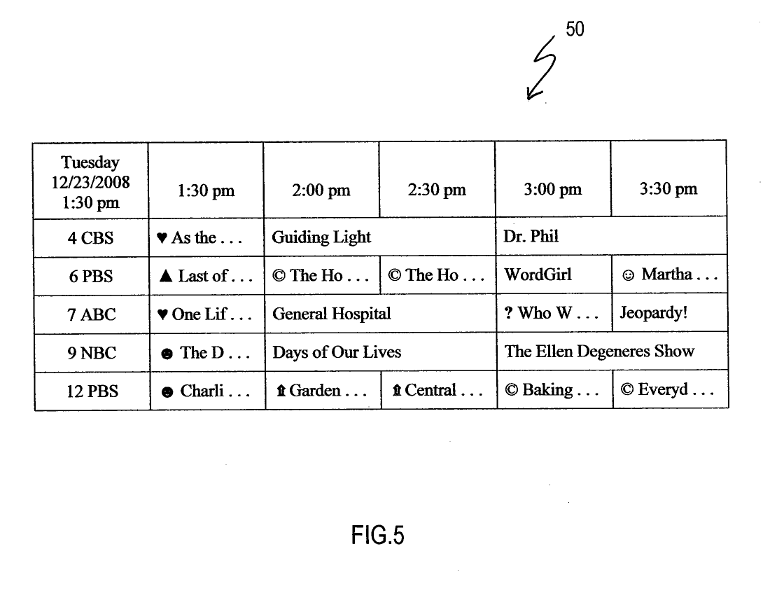

Another example of an approach that provides an enhanced EPG is illustrated in FIG. 5. In this example of an enhanced EPG displayed on the screen 50, a displayable indicator may be associated with each program of a particular genre as described above with respect to FIG. 3. However, in the example of FIG. 5, icons may be displayed only for programs for which the name is truncated. Thus, a determination may be made for each program as to whether the entire title may be displayed in the EPG displayed on the screen 50. For programs that the entire title will not be displayed, an associated icon may be displayed in addition to the truncated title as shown in FIG. 5.

It should be understood that the approaches illustrated in FIGS. 3 and 5 may be implemented together. For example, a user may be able to set options of the client device to operate in one or the other of such modes, depending on the preference of the user. Some users may always wish to have the additional genre information displayed by a displayable indicator, regardless of the informativeness of the title displayed. Other users may wish to only have the genre information displayed when the title is likely to be insufficiently informative.

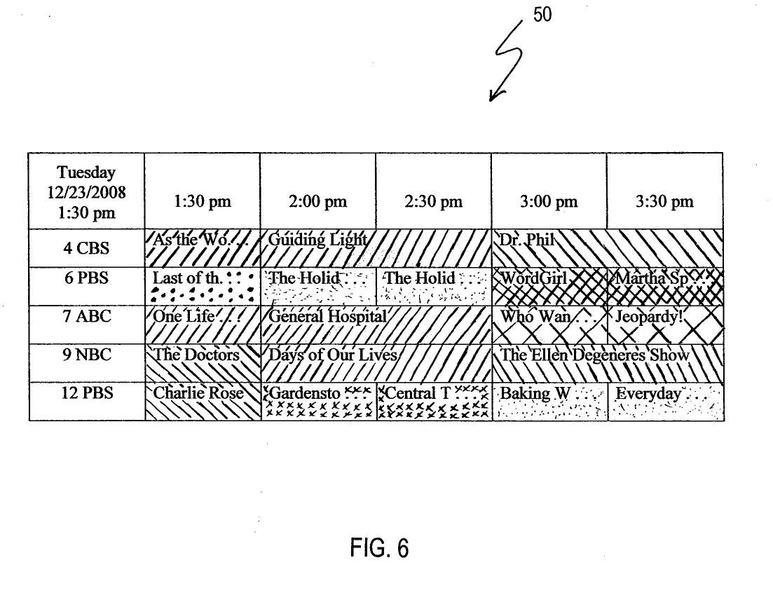

Another example of an approach that provides an enhanced EPG is illustrated in FIG. 6. In this example of an enhanced EPG displayed on the screen 50, a displayable indicator in the form of a color may be associated with each program of a particular genre. For example, a different color may be associated with each different genre, and the time slot(s) encompassed by a particular program of a particular genre may be displayed with the associated color, such as illustrated in FIG. 6. Alternatively, the encompassed time slot(s) may be outlined in the associated color. Alternatively or additionally, the name of the particular program may be displayed in the associated color.

Although not separately illustrated, it should be understood that the approach illustrated in FIG. 6 may be implemented similar to the approach illustrated in FIG. 5, such that only the programs with truncated names displayed may be displayed with the corresponding color.

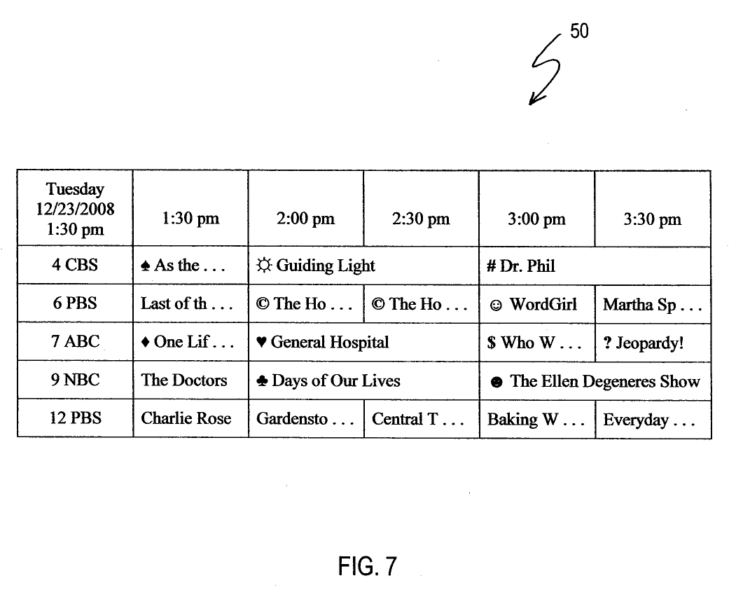

Another example of an approach that provides an enhanced EPG is illustrated in FIG. 7. In this example of an enhanced EPG displayed on the screen 50, a displayable indicator may be associated with each program of a particular program series. For example, a displayable indicator in the form of a symbol or icon, such as a “♡”, may be associated with the programs of the program series “General Hospital.” Various program series may or may not have a unique displayable indicator, such as an icon, that may be displayed in the EPG for programs of the particular series. For example, the other “soap operas” may have different displayable indicators in the form of different symbols of icons: a [symbol] may be associated with the programs of the series “As the World Turns”; a “¤” may be associated with the programs of the series “Guiding Light”; a “♦” may be associated with the programs of the series “One Life to Live”; and a [symbol] may be associated with the programs of the series “Days of Our Lives.” Other program series may or may not have an associated displayable indicator (e.g., icon), and thus other programs displayed in the EPG screen 50 may or may not include such as shown in FIG. 7.

As discussed above with respect to FIG. 4, a user may be provided with a legend of some kind that delineates the program series associated with the displayable indicators. For example, in the case of the displayable indicators in the form of icons shown in FIG. 7, a table 80 as illustrated in FIG. 8 may list each of the program series and the icons associated therewith. The table 80 may enable a user who is unfamiliar with the icons to identify an icon associated with a genre of interest, for example.

Again, it should also be understood that the program series and the icons depicted in FIG. 7 may be predetermined and transmitted to the client device for display. Alternatively, the program series may be predetermined and the particular icons to be associated with the respective program series may be selected by a user.

It should also be understood that the approach illustrated in FIG. 7 may be implemented in combination with any of the other approaches discussed herein. For example, it may be beneficial to display icons to identify particular program series, such as ones that are of particular interest to a user of the client device, and to also display colors to identify genres of programs.

It should be understood from the foregoing that the particular process or methodology of constructing the EPG is not critical and that any suitable approach as is known in the art may be employed. As such, the actual implementation of the association of genre information and/or program series information via a displayable indicator as described herein may vary as appropriate or desired for a given application.

As described herein, the use of displayable indicators may provide genre differentiation between programs in an EPG to provide a user with better insight regarding the programs, particularly those with truncated titles or names. This may facilitate user navigation through the EPG and may improve the speed with which the user may locate a program of interest.

Various processes and methodologies may be envisioned based on the foregoing description. A particular example of one process is illustrated in FIG. 9. It should be understood that the process illustrated in FIG. 9 is a relatively simplistic, high level description, and that various modifications may be envisioned for particular applications, as appropriate or desired.

The process may begin at S900, and may continue to S910, where individual displayable indicators may be associated with corresponding genres of programs. As discussed above, the displayable indicators may be defined by a television service provider, a content provider (e.g., a television network), or a user, as appropriate or desired. Next, at S920, a current EPG is determined for the current time of day and date. This may be based on the configuration of the EPG to be displayed, such as the current channel being tuned and/or viewed, the number of time slots and the number of additional channels that can be displayed at a given time.

For each of the programs to be displayed in the EPG, a determination may be made at S930 as to whether or not enough space exists in the time slot(s) allocated to the individual program for the entire title to be displayed. If the entire title may be displayed for a given program, the process may automatically consider a next program. Otherwise, when the title of the program will be truncated, either at all or to a threshold degree, the process may continue to S940, where the genre of the program may be determined and the displayable indicator associated with the determined genre is set to be displayed with the program in the EPG. When a threshold degree of truncation is employed, the threshold may be determined in any suitable manner, for example, that takes into account the relative information conveyed by the truncated title.

A determination may be made at S950 as to whether or not other programs remain to be considered. Based on such determination, the process may return to S930 or may continue to S960. At S960, a determination may be made as to whether or not a request to display the EPG is received. If not, the process may continue to S970, where a determination may be made as to whether or not a change in time slot is about to or has occurred. If not, the process may return to S960. Otherwise, the process may return to S920 to determine a current EPG for the updated time of day.

However, if a request to display the EPG is received at S960, the process may jump to S980, where the EPG including the displayable indicator(s) may be output for display. Then, at S990, either upon receipt of a request to discontinue display of the EPG or upon a predetermined elapse of time, the process may return to S960.

Again, it should be understood that the process described above with respect to FIG. 9 is only an example, and is not intended to illustrate all possible processes that may be envisioned for implementing the various features described herein. As such, although not shown for the sake of clarity and simplicity, it should be understood that the various features described above may be incorporated in the process, as appropriate or desired, or any other suitable process may be employed.

Although various details have been described herein with reference to particular embodiments, it is to be understood that these embodiments are merely illustrative of principles and applications. It is therefore to be understood that numerous modifications may be made to the illustrative embodiments and that other arrangements may be devised without departing from the spirit and scope of the present invention.

What is claimed is:

1. A process of providing an electronic program guide for display on a viewing screen, the process comprising:
providing an electronic program guide, the electronic program guide divided into at least a two-dimensional grid of timeslots containing program information corresponding to programs scheduled to be broadcast during respective ones of the timeslots; and
transmitting the electronic program guide and at least one displayable indicator from a television service provider to a client device, the at least one displayable indicator associated with at least one of the programs, indicating a genre of the at least one of the programs and configured to be displayed with the at least one of the programs in the time slot of the grid in the electronic program guide.

2. The process of claim 1, further comprising:
determining the genre of the at least one of the programs; and
associating the at least one displayable indicator with at least one of the programs based on the determined genre.

3. The process of claim 1, wherein the at least one displayable indicator is non-textual.

4. The process of claim 3, wherein the at least one displayable indicator comprises a color.

5. The process of claim 3, wherein the at least one displayable indicator comprises an icon.

6. The process of claim 1, wherein the at least one displayable indicator is configured to be displayed in the electronic program guide as a leftmost portion of the program information in the timeslot(s) of the at least one of the programs.

7. The process of claim 1, wherein the at least one displayable indicator is configured to be displayed in the electronic program guide as a portion of the program information preceding a name of the at least one of the programs in the timeslot(s) of the at least one of the programs.

8. A process of providing an electronic program guide for display on a viewing screen, the process comprising:
receiving an electronic program guide from a television service provider, the electronic program guide divided into timeslots containing program information corresponding to programs scheduled to be broadcast during respective ones of the timeslots;
associating at least one displayable indicator with at least one of the programs based on a genre of the at least one of the programs;
outputting the timeslots of the electronic program guide in an at least two-dimensional grid; and
outputting the associated at least one displayable indicator for display in the timeslot(s) of the grid of the at least one of the programs in the electronic program guide.

9. The process of claim 8, further comprising:
determining the genre of the at least one of the programs; and
associating the at least one displayable indicator with at least one of the programs based on the determined genre.

10. The process of claim 8, wherein associating the at least one displayable indicator with the at least one of the programs based on the genre of the at least one of the programs comprises determining that a name of the at least one of the programs to be displayed will be truncated as displayed in the electronic program guide.

11. The process of claim 8, wherein the at least one displayable indicator is non-textual.

12. The process of claim 11, wherein the at least one displayable indicator comprises a color.

13. The process of claim 11, wherein the at least one displayable indicator comprises an icon.

14. The process of claim 8, wherein the at least one displayable indicator is configured to be displayed in the electronic program guide as a leftmost portion of the program information in the timeslot(s) of the at least one of the programs.

15. The process of claim 8, wherein the at least one displayable indicator is configured to be displayed in the electronic program guide as a portion of the program information preceding a name of the at least one of the programs in the timeslot(s) of the at least one of the programs.

16. A computer-readable storage medium including instructions stored thereon that, when executed by a processor, cause the processor to provide an electronic program guide for display on a viewing screen by:
receiving an electronic program guide from a television service provider, the electronic program guide divided into timeslots containing program information corresponding to programs scheduled to be broadcast during respective ones of the timeslots;
associating at least one displayable indicator with at least one of the programs based on a genre of the at least one of the programs;
outputting the timeslots of the electronic program guide in an at least two-dimensional grid; and
outputting the associated at least one displayable indicator for display in the timeslot(s) of the grid of the at least one of the programs in the electronic program guide.

17. The computer-readable medium of claim 16 including instructions stored thereon that, when executed by a processor, cause the processor to:
determine the genre of the at least one of the programs; and
associate the at least one displayable indicator with at least one of the programs based on the determined genre.

18. The computer-readable medium of claim 16 including instructions stored thereon that, when executed by a processor, cause the processor to associate the at least one displayable indicator with the at least one of the programs based on the genre of the at least one of the programs by determining that a name of the at least one of the programs to be displayed will be truncated as displayed in the electronic program guide.

19. The computer-readable medium of claim 16 including instructions stored thereon that, when executed by a processor, cause the processor to output the at least one displayable indicator to be displayed in the electronic program guide as a leftmost portion of the program information in the timeslot(s) of the at least one of the programs.

20. The computer-readable medium of claim 16 including instructions stored thereon that, when executed by a processor, cause the processor to output the at least one displayable indicator to be displayed in the electronic program guide as a portion of the program information preceding a name of the at least one of the programs in the timeslot(s) of the at least one of the programs.
